(19) United States
(12) Patent Application Publication
(10) Pub. No.: US 2012/0030012 A1
(43) Pub. Date: Feb. 2, 2012

(54) YIELD OPTIMIZATION FOR ADVERTISEMENTS

(76) Inventor: Michael Fisher, Fountain Hills, AZ (US)

(21) Appl. No.: 12/844,939

(22) Filed: Jul. 28, 2010

(51) Int. Cl. G06Q 30/00

(52) U.S. Cl. 705/14.46; 705/14.4

(57) ABSTRACT

A system provides clients, such as Internet advertising networks, with the ability to select different yield optimization engines to optimize various parts of their network. The system allows clients to run simulations, using real advertising data, on various implemented engines to determine which one is the best to use. Because each ad network is different in terms of the types of ads, number of new ads entering the network, etc., the yield optimization engine producing the “best” results is unknown without trial and error. The system can combine different pricing models, including cost-per-mille (CPM), cost-per-click (CPC), and cost per action (CPA), and normalize advertisements to allow an equal comparison.

### BACKGROUND

There are several ways in which advertisements are sold over the Internet. The three most common are Cost Per Mille (CPM), Cost Per Click (CPC), and Cost Per Action (CPA).

When an advertisement is paid for based on the number of times it has been viewed, it is typically done through what is called the cost per mille (CPM). CPM is the cost per thousand times an advertisement was viewed. A view of an advertisement is often called an impression.

Another way advertisements are sold is based on how many times users click on the advertisement in order to go to the advertiser's website. This pricing model is called the cost per click (CPC). The number of clicks for a given ad is usually very low. It is not uncommon to have a “click-through” rate of 0.05% and have each click be priced at $1. Assuming these values, in order to achieve $1 in ad revenue, the advertisement must be shown 2,000 times.

The last pricing method is cost per action (CPA), wherein the advertiser pays for each user that performs some action. An example would be where an advertiser wants people to sign up for an email newsletter. In this case, the advertiser places a CPA advertisement on an ad network. When a user clicks on the advertisement, he or she is redirected to the advertiser's home page. If the user completes a registration form then the action is completed and the advertiser pays.

Large, sophisticated online advertisement networks such as Google, Yahoo, AOL, and others use very complex yield optimization algorithms to learn which advertisements in their networks are the best-yielding. Yield has several definitions depending on the pricing model that is being used, but for pay-per-click (CPC) it refers to the combination of the likelihood of the ad being viewed and the price the advertiser is willing to pay for clicks on that ad. Using the information learned about each individual advertisement, the algorithms or engines then attempt to maximize the revenue for the ad networks. Small to mid-sized companies have generally lacked the expertise or the engineering resources to implement and maintain complex yield algorithms. Yield optimization can improve revenues by orders of magnitude compared to a random selection of advertisements.

Yield optimization algorithms come from the machine learning problem referred to as the “multi-armed bandit.” This problem space describes a hypothetical challenge of determining, from a row of slot machines, which one pays out the most. This is a simple model that demonstrates the challenge of acquiring new knowledge while optimizing based on existing knowledge.

Consider a gambler arriving at a casino with a row of slot machines. The gambler has a cup of quarters and wants to maximize his winnings. He knows that each slot machine has different odds of paying out and at different amounts. The key is to determine the odds for each machine using as few quarters as possible. Use too few quarters and the gambler has an inaccurate estimate of the true odds. Use too many quarters and the gambler wastes opportunities for winning on the highest rewarding machines (computed as odds multiplied by the payout amount). The translation of this problem to the online advertising model is that the odds are equivalent to the likelihood of an ad being clicked and the reward is the price the advertiser is willing to pay for the click of their advertisement. Ad networks want to determine the accurate likelihood of an advertisement being clicked with as few impressions or views as possible.

FIG. 1 illustrates the nature of the online advertising selection environment. Suppose that there is a supply of available advertisements 101, each having a different reward that the advertiser is willing to pay in exchange for a viewer clicking on that ad. As shown in FIG. 1, ad A1 has a reward of $1, ad A2 has a reward of $2, and ad A3 has a reward of $3. Suppose further that there are four different ad “slots” 102 into which advertisements may be placed. For example, a web page may have four slots S1 through S4 into which ads may be placed. Alternatively, a web page may have a single advertising slot, but the web page may be viewed four different times by four different viewers, thus creating four advertising opportunities or slots. Similar “slots” or ad opportunities may exist in other systems, such as television broadcast advertising, where an individual ad may be selected for a commercial break in programming.

As is known, an ad selector 103 may be used to assign ads to slots in a way that is intended to maximize revenue. Various multi-arm bandit (M.A.B.) algorithms exist that attempt to select ads that will generate the maximum ad revenue based on various parameters and known data.

Suppose that ad selector 103 assigns ads in the following order to respective slots S1 through S4: A3, A1, A1, A2. In other words, ad A1 is assigned twice, and ads A2 and A3 are each assigned once.

Suppose further that after the web pages were viewed, the actual ad “clicks” registered by viewers (thus generating revenue) were as follows: A1, A1, A1, A3. The revenue associated with these clicks thus totals $6 (see element 104). Varying the ad selection algorithm can change the total revenue generated. As discussed above, ad networks would prefer to assign advertisements in a way that maximizes revenue, also known as yield optimization. Some algorithms make use of the information learned from the actual ad clicks to change the assignment of future ads. But, as discussed above, it can be inefficient to run lots of ads randomly and repeatedly to find out which ones generate the most revenue over time.

### SUMMARY

According to some variations of the invention, a system provides clients, typically ad networks, with the ability to select different yield optimization engines for optimizing various parts of their network. The yield optimization engines may include public-knowledge engines or algorithms, often published in academic journals. The system allows a user to run simulations, utilizing real advertising data, across multiple yield engines to determine which one is the best to use and (optionally) what parameters for that best engine produce optimal results. Each ad network may be generally unique in terms of types of ads, number of new ads entering the network, variance of yields, etc. Because of this uniqueness, which yield optimization engine will yield the best results may be unknown without trial and error. In some variations, each engine has variables that can be fine tuned to maximize the results. These can also be done through trial and error. Both the algorithm selection and the variable settings may be reviewed periodically as the attributes of the network can change over time.

One variation provides the ability to combine three pricing models—CPM, CPC, and CPA—along with any guaranteed amount of delivery of advertisements. (Some advertising networks guarantee to advertisers that their ad will show up a specific number of times each day.) It is common practice to combine CPM, CPC, and CPA through a calculation of eCPM (effective CPM). By normalizing different pricing models, advertisements can be compared equally.

When combining fixed guarantees with performance-based optimization, it may be difficult to serve all the guaranteed amounts while maximizing the revenue. A straight-line calculation of how many of the guaranteed advertisements to show each hour, the number guaranteed divided by 24, may produce suboptimal results because the click through rates and action rates of the performance-based ads may be different throughout the day. It could be better to serve the guaranteed advertisements during periods of low click through or user completed actions.

According to certain variations of the invention, a system and process is provided for determining an optimized yield for ad placement. Based on the results of simulations applied to real-world ad data, yields can be maximized for future placement of advertisements.

### BRIEF DESCRIPTION OF THE DRAWINGS

FIG. 1 illustrates an ad assignment scheme.

FIG. 2 shows a system including various computer-implemented processes and components that can be used to carry out principles of the invention.

FIG. 3 shows a flow chart including various computer-implemented steps that can be performed according to various principles of the invention.

FIG. 4 shows one possible webpage layout including various configuration parameters for running simulations, and for selecting parameters to use with real-world advertisements during a “production” run.

FIG. 5 shows another possible webpage layout including additional configuration parameters for running simulations and for a production run.

FIG. 6 shows a graphical display of simulation results.

FIG. 7 shows details of a process for yield optimization.

FIG. 8 shows additional details of a process for yield optimization.

### DETAILED DESCRIPTION

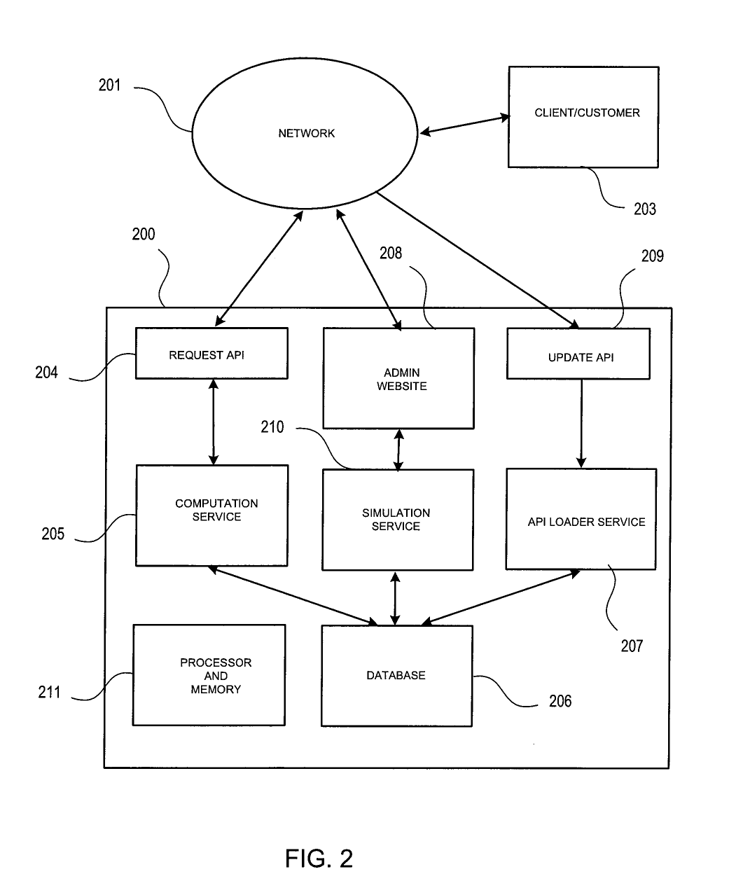

FIG. 2 illustrates a system that can be used to carry out various principles of the invention. As depicted in FIG. 2, the system 200 includes various computer-implemented processes, interfaces, and data structures arranged to perform functions as described in more detail herein. System 200 may include one or more computer processors, memories, network interfaces and other structures as are well-known in the art. Computer instructions may be included in the memories which, when executed by the one or more processors, carry out the functions and steps as described in more detail herein. Element 211 represents a processor and memory having instructions that may cause system 200 to perform functions associated with the various services, interfaces, and steps described herein.

The system 200 may be coupled to one or more networks 201, including packet-switched networks such as the Internet, to communicate with one or more client/customer devices 203. However, the inventive principles are not limited to the specific structures shown in FIG. 2, and many variations are possible. For example, the client/customer 203 may be located on the same machine as system 200 instead of being coupled to it via a network 201.

According to one variation, the system 200 comprises two application programming interfaces (APIs), three services, an administration website, and a storage database. An Update API function 209 receives inbound data transfer from clients or customers. A Request API 204 is provided for outbound request transfers to the customers. The three services include an API Loader Service 207, a Simulation Service 210, and a Computation Service 205. A database 206 stores data structures, results, and other information used to carry out various aspects of the invention.

The API Loader Service 207 receives input (e.g., ad data) from the Update API 209 and loads it into the database 206. The Simulation Service 210 runs simulations for the customers as explained in more detail herein. The Computation Service 205 is used to run the calculations for the customer's data and sends it to the Request API 204 for retrieval by the customer, indicating which ads should be run to maximize revenue. The Administration Website 208 may be used for changing configuration settings and for running the simulations.

The Update API 209 may be used by clients to send actual advertisement response data into the system. The data set may include a unique identifier for the customer, the API password, and all the advertisements (items) that have been shown in the past epoch (e.g., a time period that may equate to 15 min intervals). Along with the unique identifier for the advertisement are included data such as the number of times that particular advertisement was displayed during the epoch, the reward or amount advertisers were willing to pay for clicks or displays of that advertisement, the number of times that the advertisement was clicked or selected, and if there were any guaranteed impressions for that advertisement. This API may include the following data fields, further details of which are provided later in this document:

client_id
password
input vector {
int client_id;

int item_id;
int item_actions;
int item_impressions;
float item_reward;
int item_category;
int item_type;
int item_guaranteed;
char insertion_dt[25];

}

Request API 204 may be used by clients to retrieve results data from the system 200. The data may be requested in one of two manners, all data or a specific number of advertisement ids >=1. The client sends a unique client id, password, category, number of ads requested, and an empty results vector. In one variation, the API returns the result vector with the appropriate number of advertisement ids (i.e., a proposed assignment of advertisements to maximize revenue). The frequency (and, optionally, the order) of ad IDs in the vector may be determined to maximize the combination of revenue and learning. One possible vector format is the following:

client_id
password
category
number_ads (0 = all)
result vector {
int client_id;

int item_id;

int item_category;
}

The API Loader Service 207 may be used to improve the performance in terms of response time of the Update API 209. In one variation, instead of having the Update API write directly to the database, it writes locally to the disk. API Loader Service 207 monitors a directory on the server and when the data is loaded, it runs a script to upload the data into the database and set a flag to alert the Computation Service 205 that new data is ready to be processed.

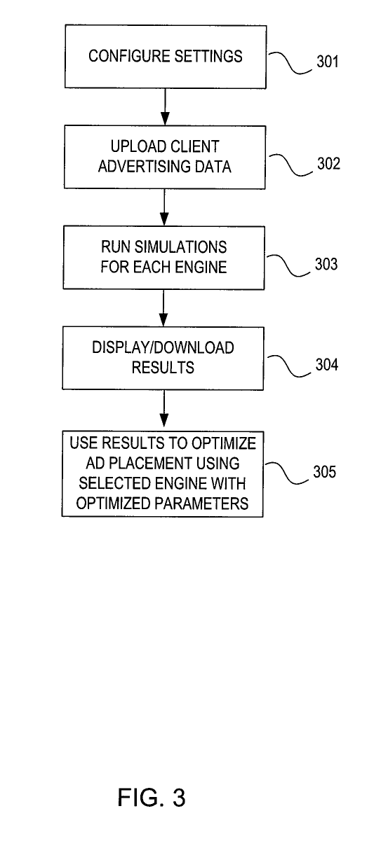

In its most basic form, various computer-implemented steps may be practiced to carry out the principles of the invention. As shown in FIG. 3, the steps may include a first step 301 of configuring settings for the system. As discussed below, this may include changing parameters used by the various simulation engines to adapt to a particular advertising environment and/or user preferences.

In step 302, client data including advertisement response data (i.e., real-world selections of the ads) is uploaded into the system. As explained above, the data may be input using an API that includes an input vector including advertisement IDs along with information about the number of impressions, rewards, and other information associated with each advertisement that was clicked (or viewed or acted upon) by viewers. Further details of this data structure are described below.

In step 303, simulations are run using multiple engines using the client data. This is discussed in more detail below. In step 304, the results of the simulations across multiple engines are displayed and/or stored, and the results are downloaded to the client. In one variation, the engine (or engines) that produced the best (maximized) revenue is used to select future advertisements. Based on the results of the simulation, in step 305 future ad placements are optimized to maximize revenue using one or more selected engines with (optionally) engine parameters selected to correspond to the simulated outcomes.

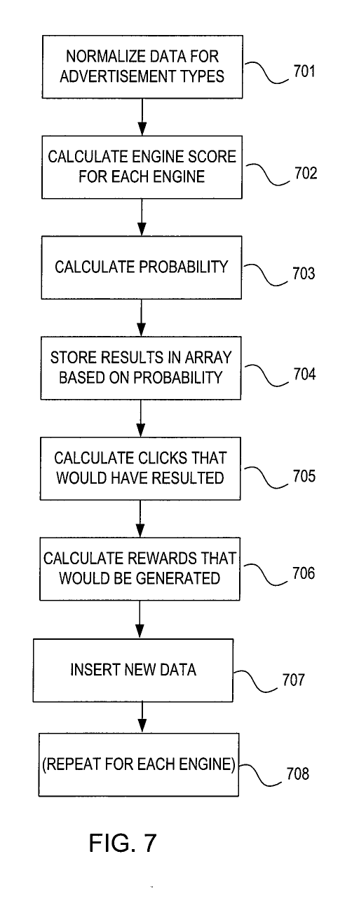

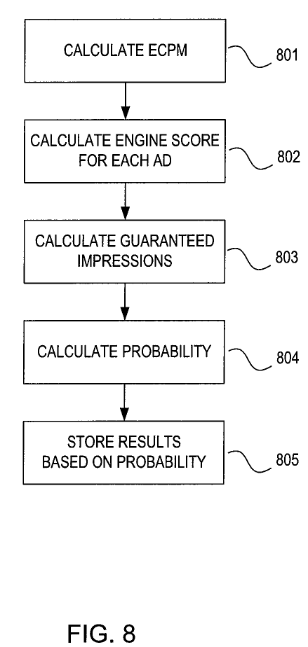

As explained in more detail below, because advertisement response rates and other characteristics may fluctuate over time (e.g., time of day, day of the week, etc.) multiple simulations may be performed while adjusting various parameters. Furthermore, clients may adjust simulation parameters for different simulation engines to more closely match the characteristics of their advertising networks. Further details of the steps shown in FIG. 3 are described below, particularly in connection with FIGS. 7 and 8.

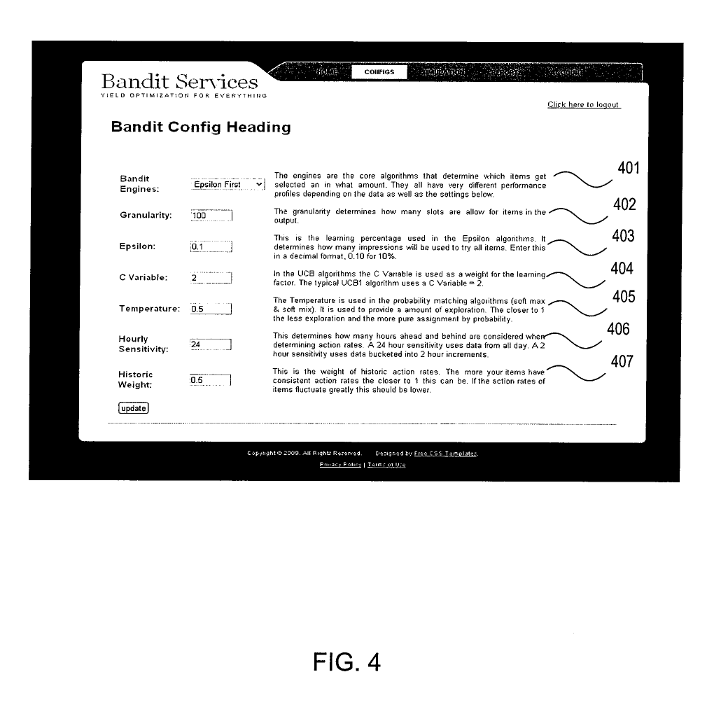

Turning to FIG. 4, clients may interface to the system using a web-based interface to configure various settings, run simulations, and to display results by using an Admin Website tool 208 (see FIG. 2). FIG. 4 shows one possible interface including an arrangement of settings. A first setting 401 may indicate which simulation engine or engines to run for a particular category or publisher suite of advertisements. Various engines may be included in the system. Algorithms such as those described in J. Vermorel and M. Mohri, Multi-Armed Bandit Algorithms and Empirical Evaluation (Machine Learning: ECML 2005, pages 437-448), selected portions of which are attached as Appendix A, and D. Chakrabarti et al., Mortal Multi-Armed Bandits, Advances in Neural Information Processing Systems, may be included in the system as engines to run the simulations and to select ads after the simulations are completed.

The user interface shown in FIG. 4 may be used both for simulations and, after conducting one or more simulations, for running “live” data with a selected engine and parameters. In other words, simulations may be run using different engines (each having its own parameters) and, following the simulations, the engine (and its associated parameters) that produced the optimum results may be activated and run using real advertisements.

In one variation, the following engines may be included in the system, in addition to a random selection algorithm (i.e., ads are randomly selected without regard to an engine):

Epsilon-greedy strategy: The best lever (i.e., the best advertisement, such as the one that was most frequently selected by viewers) is selected for a proportion 1−ε of the trials, and another lever (ad) is randomly selected (with uniform probability) for a proportion ε. A typical parameter value might be ε=0.1, but this can vary widely depending on circumstances and predilections.

Epsilon-first strategy: A pure exploration phase is followed by a pure exploitation phase. For N trials in total, the exploration phase occupies εN trials and the exploitation phase (1−εs)N trials. During the exploration phase, a lever (i.e., advertisement) is randomly selected (with uniform probability); during the exploitation phase, the best lever (ad) is always selected.

Soft Max (Boltzmann Exploration): Probability matching strategies reflect the idea that the number of pulls for a given lever or ad should match its actual probability of being the optimal lever. It is random choice according to Gibb's distribution. Lever i is chosen with probability

$${ρ}_{i} = \frac{e \frac{{\hat{μ}}_{i}}{τ}}{{\sum }_{j = 1}^{n} {e}^{\frac{{\hat{μ}}_{j}}{τ}}}$$

where \hat{μ}ᵢ is the estimated mean of the rewards of lever i and τ is a parameter called temperature.

Soft Min: Same as above but replace temperature by

τ₀ ln(n)/n

where t is the temperature variable and n is the number of impressions.

UCB1: Algorithms that allow for only deviation from the optimal total payoff by O(ln t)

$${\overline{χ}}_{j} + \sqrt{\frac{c ln ( n )}{{n}_{j}}}$$

where the first term is the average of rewards from machine j, ensures optimal arm is played frequently. The second term is the learning factor. An arm that has a low number of plays will have a higher value for the second term and therefore will get played.

UCB Normal. Here the reward distribution is assumed to be normal, so sample variance is used to estimate population variance in the upper confidence bound. Loop: For each n=1, 2, . . . . If there is a machine which has been played less than 8 log(n) times then play this machine. Otherwise play machine j that maximizes:

$${\overline{χ}}_{j} + \sqrt{16 \frac{{q}_{j} - {n}_{j} {\overline{x}}_{j}^{2}}{{n}_{j} - 1} \frac{ln ( n - 1 )}{{n}_{j}}}$$

where qj is the sum of the squared rewards obtained from machine j and where n is the number of impressions of an advertisement being evaluated.

Update average and sum of squares of reward.

Advertisements may be grouped by contextual categories or topics such as sports, news, and entertainment. They can also be grouped by which publisher the advertisement is able to be run on, sometimes called site specific advertisements.

Returning to FIG. 4, a granularity setting 402 determines how many “slots” are allowed for items in the output. For example, a setting of 100 would allow for 1 slot for each percentage point that an advertisement should show up in rotation. Suppose that ad A should be shown 20% of the time and ad B should be shown 15% of the time. In the 100 slots of the array, ad A's ID would be placed in 20 slots and ad B's ID in 15 slots.

A third setting epsilon 403 indicates a learning percentage used in the Epsilon algorithms. This is the epsilon value as discussed above in the Epsilon-greedy and Epsilon-first algorithms. It is the percentage of impressions that are given to learning instead of maximizing revenue. It determines how many impressions will be used to try all items.

A fourth setting C variable 404 indicates a weight for the learning factor. This is the variable C in the UCB1 algorithm discussed above. It is a weighting variable used in the numerator of the learning factor in the algorithm.

A temperature setting 405 is used in a probability matching algorithm to provide an amount of exploration. The temperature variable is the variable “t” in the Soft Max and Soft Min algorithms as described above. The estimated mean of the rewards (revenue) is divided by this temperature variable and the result is used to raise the mathematical constant “e” or 2.71828 to a power.

An hourly sensitivity setting 406 determines how many hours ahead and behind are to be considered when determining action rates. For example, a 24-hour sensitivity uses data from all day, whereas a two-hour sensitivity uses data bucketed into two-hour increments.

A historic weight setting 407 provides a weight of historic action rates. The more items have consistent action rates, the closer to 1 this parameter can be set. If the action rates fluctuate greatly, this should be set lower.

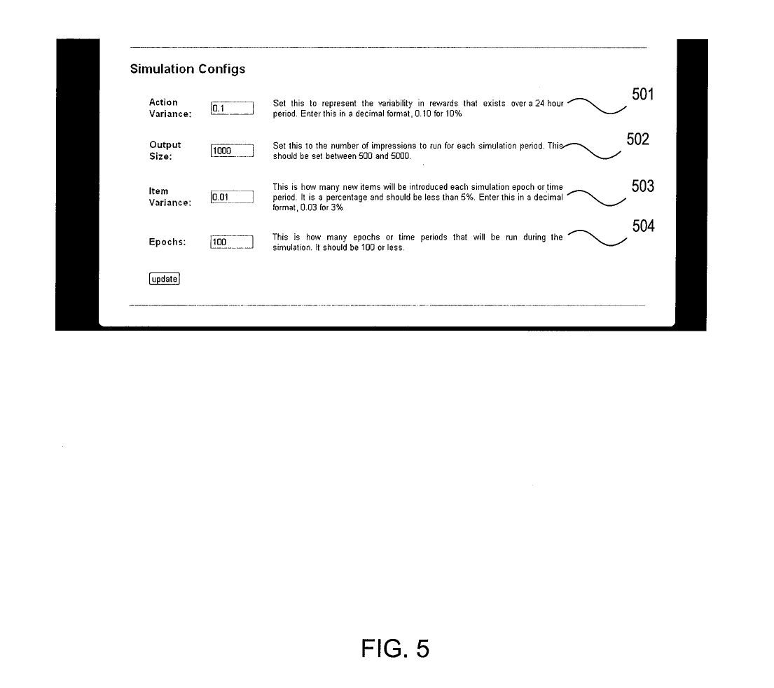

FIG. 5 shows additional configuration settings that can be used to adjust the simulations (and, during production runs, the actual engine performance). The settings may include an action variance 501, output size 502, item variance 503, and number of epochs 504.

The action variance 501 represents the variability in rewards that exists over a 24 hour period. Advertisers can change how much they are willing to pay for an advertisement throughout the day; the difference between the maximum and minimum price would be the variation.

The output size 502 is the number of impressions to run for each simulation period. Since some networks run much smaller or larger amounts of impressions than other networks during an “epoch” (e.g., approximately 15 minute period), the simulation allows for adjusting how many impressions should be simulated during each epoch.

The item variance 503 indicates how many new ads will be introduced each simulation epoch or time period. Since some networks have much smaller or larger amounts of new advertisements introduced during an epoch, the simulation allows for adjusting how many new advertisements should be simulated as being introduced during each epoch.

The number of epochs 504 is the number time periods that will be run during the simulation.

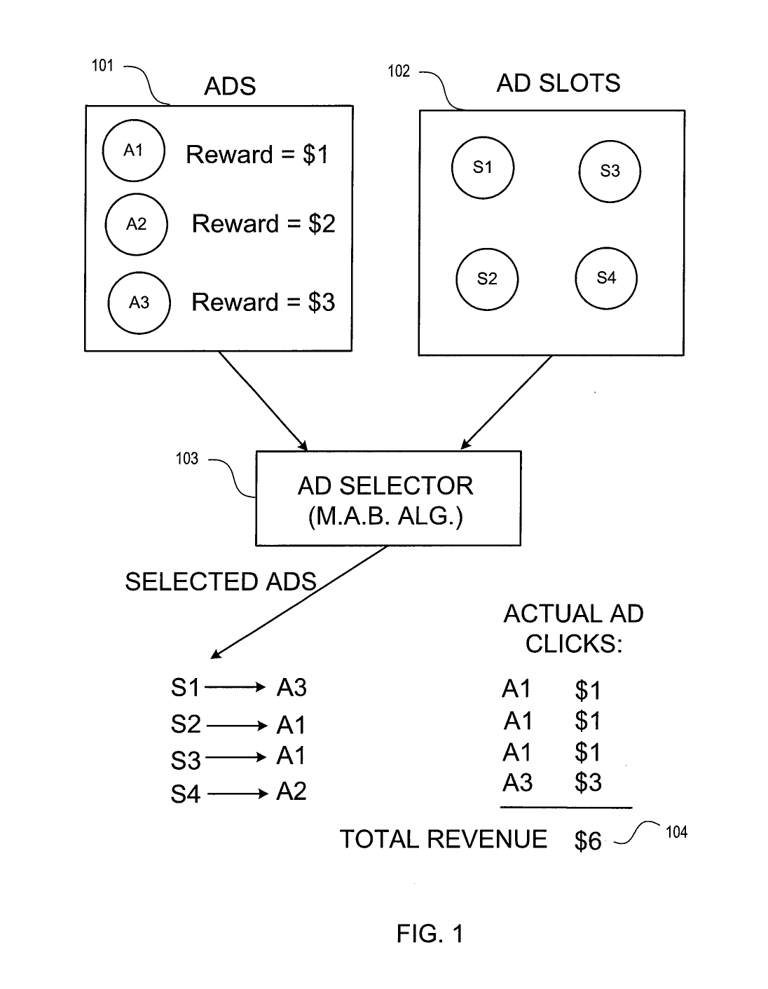

The simulation (step 303 in FIG. 3) is run by Simulation Service 210 (see FIG. 1) and then the results can be displayed through the Admin website 208.

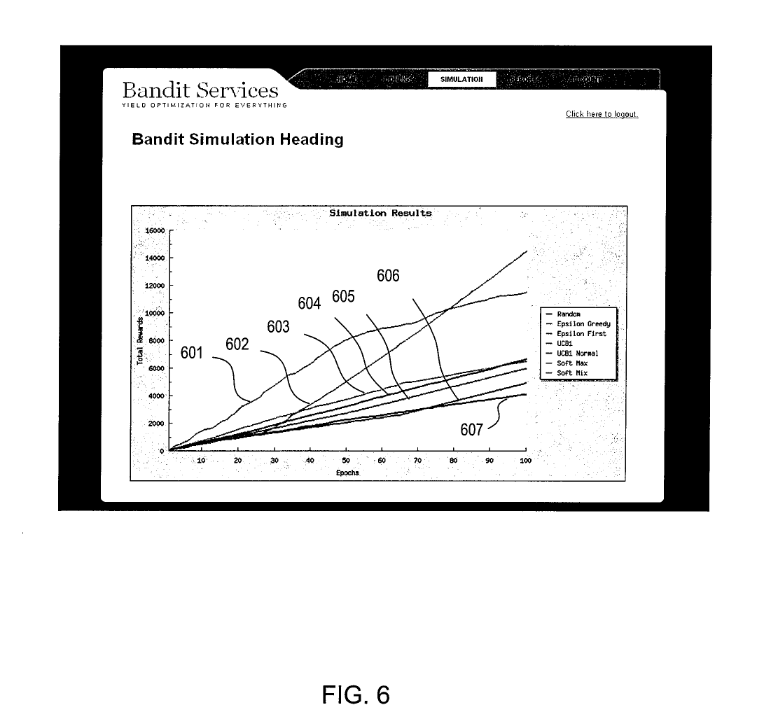

Turning to FIG. 6, the cumulative rewards that would have been accumulated with each of the various engines can be depicted on a composite graph. (The actual results may be color-coded for easier visual analysis). In FIG. 6, graph 601 represents simulation performance results for the UCB1 Normal engine; graph 602 represents simulation performance results for the Soft Max engine; graph 603 represents simulation performance results for the UCB1 engine; graph 604 represents simulation performance results for the Soft Mix engine; graph 605 represents simulation performance results for the Epsilon Greedy engine; graph 606 represents simulation performance results for the Epsilon First engine; and graph 607 represents simulation performance results for a random selection engine.

As shown in FIG. 6, the UCB1 Normal engine 601 performed well in the beginning of the day but then was ultimately outperformed by the Soft Max engine 602. Based on this simulation, the user may choose to run the UCB1 Normal engine during the first part of the day (with real advertisements), then switch over to using the Soft Max engine 602 later in the day. Alternatively, the Soft Max engine might be selected to run for the entire period using real advertisements.

Further details of the Simulation Service 210 (FIG. 2) and simulation step 303 (FIG. 3) will now be described with reference to the flowchart shown in FIG. 7. Simulation Service 210 may be invoked via the Admin Website 208 to calculate the total rewards for a set of data. It does this by running each of the engines against the same set of ad data for the number of epochs set in the configuration. Results for each engine are stored in a data file. When the service is complete with the calculations, a semaphore is set to notify Admin Website 208 to display the graphs based on the data in the files.

As described above, four primary configuration settings, set in the Admin Website 208, may be used to adjust the simulation. The settings include the action variance, the output size, the item variance and the number of epochs.

The simulation may use these settings in the following manner. The data from the client that is to be used in the simulation run is loaded into a vector (an in-memory array of data). Various parameters regarding each advertisement may be loaded into the vector, such as:

(0) client_id

(1) item_id (i.e., advertisement ID)

(2) item_type (CPC, CPA, CPM)

(3) item_actions (summed)

(4) item_impressions (summed)

(5) historic_action_rate (averaged)

(6) item_reward (price or revenue)

(7) item_category (classification of where the ads should run)

(8) item_guarantee (if any amount of impressions have been guaranteed for this ad)

The vector above differs slightly from the input vector described previously in connection with the application programming interface (API), in that the above vector also includes (5) historic_action_rate (averaged). This parameter may comprise the number of click-through rates averaged over time. The item_category parameter may be used to indicate a category such as news, sports, or financial.

The Simulation Service 210 then completes various steps for each epoch and then repeats the process for each engine. These steps are illustrated in FIG. 7 and are explained in more detail below. More or fewer steps may be included in various embodiments of the invention.

The following is pseudo code for the nested loops of calculating for each epoch and engine:

Start simulation (
Store initial data set in vector

For x from Engine # 1 to Engine # N (

For y from 1 to Number of Epochs (

Seven Step Process - FIG. 7

)

)

)
Finish Simulation

As shown in FIG. 7, a first step 701 may be used to normalize the data for various types of advertisements (CPC, CPM, CPA). This can be done through an eCPM calculation, which is used to adjust the engine score for each advertisement (item) in the data vector. eCPM is the “effective CPM” and can be calculated for CPC ads as:

price per click*number of clicks/number of impressions/1000

For CPA priced ads it is calculated as:

price per action*number of actions/number of impressions/1000

A second step 702 may be used to calculate the engine score of each advertisement. This may be done differently for each engine. In one variation, each engine may provide a score per ad as its first step. As explained above, in one variation there may be six engines plus a random selection that is used (i.e., ads are randomly selected and the results are obtained for that scenario).

A third step 703 may be used to take the total engine score of all advertisements (items) and the individual engine score to calculate a probability by dividing each individual score by the total. The probability indicates how often the ad should be shown in relation to other ads in that same category. For example, if there are 3 ads and ad A has a score of 2, ad B a score of 3, and ad C a score of 5, the probability or percent that they should be shown for ad A is 2/(2+3+5)=20%, ad B is 3/(2+3+5)=30%, and ad C is 5/(2+3+5)=50%.

A fourth step 704 may be used to place each advertisement ID into a result vector the appropriate number of times to emulate the percentage of times that the ad corresponding to the ID should be shown over the next epoch, as shown below:

Key

| | 1 | 2 | 3 | . . . | N |
|---|---|---|---|---|---|
| Value | Item 1 | Item 1 ID | Item 2 ID | . . . | Item X |
| | ID | | | | ID |

An example of how this can be done is with the following set of data from an engine's calculation as shown below:

| | Ad ID | | |
|---|---|---|---|
| | A | B | C |
| Engine Score | 6 | 10 | 4 |
| Probability of | 0.3 | 0.5 | 0.2 |
| display | | | |

The Engine Score of ad A is 6, divided by the total engine score 6+10+4=20, results in 0.3 or 30% probability of being displayed for ad A. Therefore the resultant array would be created as shown below:

| | | | | | | | | | |
|---|---|---|---|---|---|---|---|---|---|
| B | B | B | B | B | A | A | A | C | C |

Item A would be inserted 3 times in an array that had 10 locations. If the array size as set in the configuration setting, output size, was 100 then item A would be displayed 30 times in the array. In one variation, the ordering of the ads in the vector does not matter—i.e., only the relative frequency of each ad is taken into account when creating the vector. In other variations, the ordering may be randomized or ordered according to any of various criteria.

Once these calculations are performed and the result array is established, the fifth step 705 is for the simulation to determine the appropriate number of clicks that would most likely have resulted if this result set was actually used in production. The manner in which it does this is by using the existing click rate data, current and historic over the hourly sensitivity as weighted by the historic weight variable, along with the action variance configuration setting.

The current and historic data is retrieved based on the hourly sensitivity variable. If set to 24 hours, then all of the current day's data and all of the historic data is used. If set to something less, such as 2 hours, then only the last two hours of today's data and the same two hour period historically is used. The historic data is multiplied by the historic weight to provide a manner in which to lessen the importance of historic data as compared to today's data. The reason is that advertisements often have lifecycles in which their performance, click through rate, first improves and then degrades over time, in somewhat of a bell shaped curve. This current+historic calculation is used together as an action rate. A probability distribution is constructed using the action rate as the mean, μ, with the action variance as the distribution variance, δ². Using this probability distribution, the number of likely clicks per ad is calculated.

The sixth step 706 is to calculate the rewards that would be generated from these clicks. This is just the number of clicks (calculated in the step above) multiplied by the reward per click. These are multiplied by the reward and summed as the total reward. This number is stored in memory in order that the running total over all epochs can be calculated.

After the calculation of the clicks and rewards is performed, step 707 is performed. This involves introducing into the original data set stored in the vector a set of new “dummy” advertisements based on the item variance configuration. In other words, new ad IDs may be generated at random and added to the original data set. (During the actual production run of data, the “dummy” advertisements could be replaced with real “live” new advertisements). This is to approximate the amount of new advertisements that are added to the client's network daily. The user sets this value as a percentage typically below 5% (higher amounts of new advertisements are not likely). The simulation uses this percentage to calculate how many new items should be added. These are appended to the data vector and the next epoch's calculations are started.

In step 708, the steps may be repeated for each engine.

To simulate new advertisements entering the system, the user may enter a percentage of new ads. This number is multiplied by the total number of ads in the system and the result is the number of new ads to append to the vector with no historic data. The next simulation epoch treats these as new advertisements. Each engine calculates a new result vector that includes learning impressions for these new advertisements.

The Computation Service 205 (see FIG. 2) may be used to determine the actual advertisements or items that the client should display over the next epoch. This service “wakes up” periodically, set for example at three-minute intervals, and checks the semaphore flags to see if new data has arrived. If it has, it selects the client's configuration settings that include the engine to run, the variables to use with the engine, the size of the output vector, the hourly sensitivity, and the historic weight. These are used in the process of generating a new result vector that is used by the Request API by clients to determine which advertisements or items to display. The data that is to be used in the calculations is retrieved from the database and is loaded into a vector (an in memory array of data).

After the configurations are retrieved and the data is stored in a vector, the process illustrated in FIG. 8 may be used to run the actual production data using a selected engine with selected parameters.

A first step (step 801 in FIG. 7) may be to normalize the data for various types of advertisements (CPC, CPM, CPA). This is done through an eCPM calculation (see above) to calculate the engine score for each advertisement (item) in the data vector.

A second step 802 may be to calculate the engine score of each advertisement. This may be done differently depending on the engine.

The third step 803 is to calculate the guaranteed impressions. This may involve calculating how many of the guaranteed impressions for a particular advertisement should be displayed in the next epoch.

In order to do this in a manner that minimizes the potential reduction of revenue, a unique method has been developed. The system calculates the Required Impression Amount (RIA) for the current epoch. The calculation for the RIA of each advertisement is to select the greater of 1) the percentage of the number of impressions guaranteed to the total number of impressions for the hour or 2) the percentage of hourly impressions for a particular category of advertisements multiplied by the total action rate (click through rate). This is essentially comparing the likelihood of getting an action (click) based on the number of historic impressions with the percentage of impressions required by the guarantee and selecting the highest. The equation is:

if (guar/total_imps>hrly_perc*action_rate_total) RIA=guar/total_imps;

else RIA=hrly_perc*action_rate_total;

where: guar=number of impressions guaranteed for the particular advertisement

where total_imps=total number of impressions for the hour

where hrly_perc=percentage of hourly impressions for a particular category of advertisements

where action_rate_total=total engine score

If the RIA, as calculated above, is greater than the engine score of the particular advertisement then the RIA is substituted for the engine score. If not then the engine score is used in the following steps even though this advertisement has a guarantee. The reason is that it is performing at a rate that will have it shown more often than its guarantee would.

The fourth step 804 is to use the total engine score of all advertisements (items) and the individual engine score to calculate a probability by dividing each individual score by the total.

The final step 805 is to place each advertisement ID into a result vector the appropriate number of times corresponding to the percentage of times that the ID should be shown over the next epoch.

As discussed above, with the multi-armed bandit problem, the key for the gambler is to determine the odds for each slot machine using as few quarters as possible. Use too few quarters and the gambler has an inaccurate estimate of the true odds. Use too many quarters and the gambler wastes opportunities for winning on the highest rewarding machines (computed as odds multiplied by the payout amount).

In online advertising, the odds are equivalent to the likelihood of an ad being clicked and the reward is the price the advertiser is willing to pay for the click of that advertisement. Ad networks need to determine the accurate likelihood of an advertisement being clicked with as few impressions or views as possible. If an ad network's inventory of ads never changed, they could determine the best performing ads and only serve them in order to maximize their revenue. However, in most ad networks the inventory of advertisements is constantly changing. Some ads are running out of budget while new ones are being added by new advertisers. These changes require the ad network to constantly be learning how new ads will perform while attempting to maximize revenues. The algorithms described herein provide various approaches to solving this problem of both learning and maximizing revenue simultaneously. For the exact same data set, each algorithm produces slightly different results (recommendations of which ads to show). Having the ability to simulate each algorithm allows a determination of which algorithm will perform the best in the real world for each advertising network.

What is claimed is:

1. A method of optimizing placement of advertisements, comprising:
(1) receiving, in a computer, data representing a plurality of advertisements;
(2) in the computer, running the data representing the plurality of advertisements through a plurality of engines each producing a score; and
(3) based on step (2), generating an optimized set of the advertisements for placement using one or more of the plurality of engines.

2. The method of claim 1, further comprising receiving in the computer configuration settings for one or more of the plurality of engines.

3. The method of claim 2, wherein at least one of the configuration settings controls an amount of exploration.

4. The method of claim 2, wherein at least one of the configuration settings controls an extent to which historical data is used to generate the optimized set of the advertisements for placement.

5. The method of claim 1, wherein the plurality of engines perform a multi-arm bandit simulation.

6. The method of claim 1, further comprising normalizing data representing the advertisements based on a type of each advertisement.

7. The method of claim 1, wherein the optimized set of the advertisements corresponds to a maximized cumulative revenue.

8. The method of claim 1, wherein the optimized set of the advertisements satisfies a guaranteed minimum ad placement criterion.

9. The method of claim 1, wherein the plurality of engines are selected from the set consisting of a random selection engine; an Epsilon Greedy engine; an Epsilon First engine; a UCB1 engine; a UCB1 Normal engine; a Soft Max engine; and a Soft Mix engine.

10. The method of claim 1, wherein the data representing a plurality of advertisements indicates how many times each advertisement was actually selected in a prior time period.

11. An apparatus comprising:
a processor; and
memory having stored therein instructions which, when executed:
receive data representing a plurality of advertisements;
run the data representing the plurality of advertisements through a plurality of engines each producing a score; and
based on the score, generate an optimized set of the advertisements for placement using one or more of the plurality of engines.

12. The apparatus of claim 11, wherein the instructions when executed receive into the apparatus configuration settings for one or more of the plurality of engines.

13. The apparatus of claim 12, wherein at least one of the configuration settings controls an amount of exploration.

14. The apparatus of claim 12, wherein at least one of the configuration settings controls an extent to which historical data is used to generate the optimized set of the advertisements for placement.

15. The apparatus of claim 11, wherein the plurality of engines perform a multi-arm bandit simulation.

16. The apparatus of claim 11, wherein the instructions when executed normalize data representing the advertisements based on a type of each advertisement.

17. The apparatus of claim 11, wherein the optimized set of the advertisements corresponds to a maximized cumulative revenue.

18. The apparatus of claim 11, wherein the optimized set of the advertisements satisfies a guaranteed minimum ad placement criterion.

19. The apparatus of claim 11, wherein the data representing a plurality of advertisements indicates how many times each advertisement was actually selected during a prior time period.

20. The apparatus of claim 11, wherein the data representing a plurality of advertisements indicates how many times each advertisement was selected.

21. The apparatus of claim 11, wherein the plurality of engines are selected from the set consisting of a random selection engine; an Epsilon Greedy engine; an Epsilon First engine; a UCB1 engine; a UCB1 Normal engine; a Soft Max engine; and a Soft Mix engine.
